(19) United States
(12) Patent Application Publication
(10) Pub. No.: US 2025/0178485 A1
(43) Pub. Date: Jun. 5, 2025

(54) RAMP ASSEMBLY FOR GUIDING AN ELECTRICAL CONDUCTOR SYSTEM

(71) Applicant: Caterpillar Inc., Peoria, IL (US)

(72) Inventors: Igor STRASHNY, Tucson, AZ (US); Jason SCHAFER, Rapid City, SD (US); Bhaskara DADDUPADUVARI, Dunlap, IL (US); Zhaoxu DONG, Dunlap, IL (US); Brian WELLER, Chillicothe, IL (US); Roopa RAJESH, Tucson, AZ (US)

(73) Assignee: Caterpillar Inc., Peoria, IL (US)

(21) Appl. No.: 18/524,503

(22) Filed: Nov. 30, 2023

(51) Int. Cl. B60M 1/32; B60L 5/40

(52) U.S. Cl. CPC B60M 1/32; B60L 5/40

(57) ABSTRACT

A ramp assembly for guiding an electrical conductor system for a mobile machine onto a conductive rail assembly. The ramp assembly may include an ingress ramp assembly with a variable width, located at one end of the conductive rail assembly, and extend to a height above the conductive rail assembly, where a transition section guides the electrical conductor system onto the conductive rail assembly. The ramp assembly may also include an egress ramp for removing the electrical conductor system from the conductive rail assembly.

### TECHNICAL FIELD

The present disclosure relates generally to supplying electrical power to a mobile machine, and more specifically, to a ramp system for guiding an electrical conductor onto or off an electricity-conducting rail system that supplies electricity to the mobile machine.

### BACKGROUND

Mobile industrial machines, such as earth-moving machines, can be of substantial weight and can bear immense loads, thus requiring a large amount of power. Many industrial machines are driven by internal combustion engines. However, internal combustion engines have drawbacks such as fuel costs, fuel transport difficulties, and detrimental engine emissions. Accordingly, there has been a movement toward powering large mobile industrial machines with hybrid or all-electric power systems.

While hybrid and all-electric power systems for industrial machines are beneficial for alleviating fuel costs and emission concerns, these systems present challenges. For example, the use of hybrid or all-electric systems in an industrial capacity requires a significant investment in infrastructure, particularly due to the location of industrial worksites. While the use of overhead electricity-conducting lines is one solution for powering vehicles with predetermined routes or terrain (e.g., trains, subways, buses, etc.), overhead lines are not practical for all machines or worksites, such as freely-steerable industrial machines and worksites with uneven terrain. As a result, existing power systems, such as overhead lines, are not typically used in remote and uneven environments. Further, it can be difficult to properly align and couple such power conducting lines to a machine for proper energy transfer. Such problems can lead to project delays and machine downtime.

A system for providing electric power to a traveling vehicle is described in International Patent App. Pub. No. WO 2020/186296 A1, published on Sep. 24, 2020 (“the '296 publication”). The system described in the '296 publication includes an electrical delivery system at a mine site for a moving vehicle where two electricity conductors are anchored to relocatable roadside barriers. In order to charge the moving vehicle, the delivery system provides a retractable arm extending from the vehicle that aligns with electrical connectors embedded within a horizontal channel of the roadside barriers. While the system described in the '296 publication may be helpful in some circumstances, the '296 publication does not describe a system to connect or disconnect the electrical delivery system to the roadside electrical conductors.

Aspects of the present disclosure may solve one or more of the problems set forth above and/or other problems in the art. The scope of the current disclosure, however, is defined by the attached claims, and not by the ability to solve any specific problem.

### SUMMARY

In one aspect, an electrical conductive system for a free-steering mobile machine, including a conductive rail assembly including a plurality of conducting rails extending generally parallel to the ground, the plurality of conducting rails configured to provide electricity to the free-steering mobile machine; and an ingress ramp assembly located at one end of the conductive rail assembly, the ingress ramp assembly including: a plurality of non-conducting rails detached from the plurality of conducting rails, and extending to a height above the conductive rail assembly.

In another aspect, an electrical conductive system for a free-steering mobile machine, including: a conductive rail assembly including a plurality of conducting rails extending generally parallel to the ground, the plurality of conducting rails configured to provide electricity to the free-steering mobile machine; and an ingress ramp assembly located at one end of the conductive rail assembly, the ingress ramp assembly including: a plurality of non-conducting rails extending to a height above the conductive rail assembly and wherein an width of the ingress ramp assembly provided by the plurality of non-conducting rails narrows in a direction toward the conductive rail assembly.

In yet another aspect, a method of using an ingress ramp assembly to align a contactor assembly of a free-steering mobile machine onto a conductive rail assembly, including: aligning the contactor assembly onto an upstream portion of the ingress ramp assembly; sliding the contactor assembly on a top surface of the ingress ramp assembly and up the ingress ramp assembly to a height above the conductive rail assembly; and lowering the contactor assembly onto the conductive rail assembly.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a side view of a mobile machine coupled to a conductive rail assembly with an ingress ramp assembly and an egress ramp assembly, according to aspects of the present disclosure.

FIG. 2 is an angle view of the ingress ramp assembly, as shown in FIG. 1.

FIG. 3 is a top view of the ingress ramp assembly, as shown in FIG. 2.

FIG. 4 is a side view of the ingress ramp assembly, as shown in FIG. 2.

FIG. 5 is a front, cross-section view of a section of the ingress ramp assembly and a rail connector assembly, as shown in FIG. 1.

FIG. 6 is a top view of the egress ramp assembly, as shown in FIG. 1.

FIG. 7 is a flowchart depicting an exemplary method for guiding a powered rail connector from a mobile machine onto a conductive rail assembly.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of +10% in the stated value.

As used herein, the term “upstream” is intended to cover the components, parts, assemblies, and systems located at an entry end or a proximal portion of a ramp assembly or a conductive rail assembly. Conversely, the term “downstream” is intended to cover the components, parts, assemblies, and systems located at an exit end or a distal portion of the ramp assembly or the conductive rail assembly.

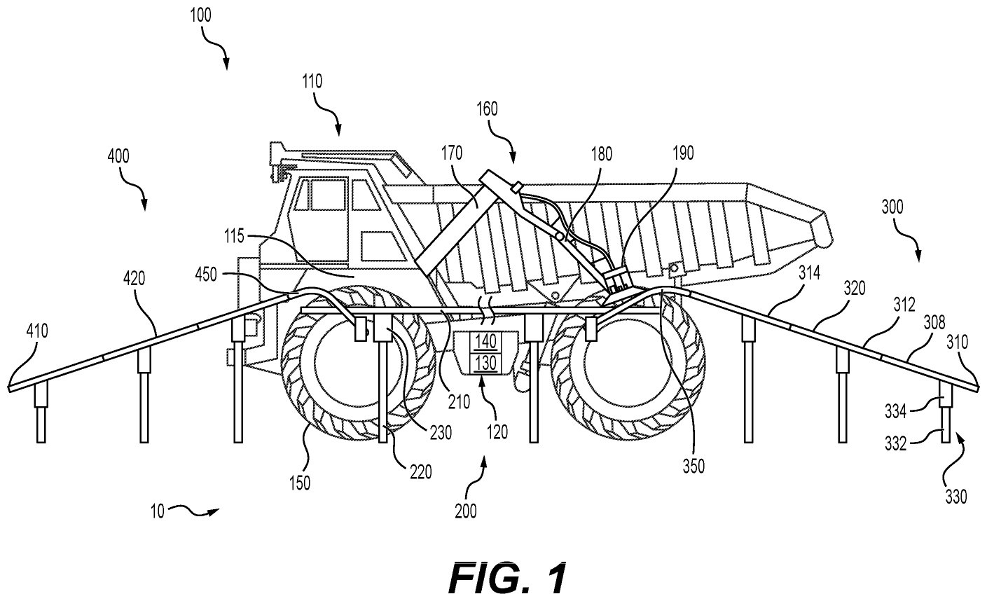

FIG. 1 depicts a mobile machine power system 100 including a mobile machine 110 with a rail connector assembly 160, a conductive rail assembly 200, and an ingress ramp assembly 300 and egress ramp assembly 400 at an upstream end and a downstream end, respectively, of the conductive rail assembly 200. The mobile machine 110 is free-steering, allowing the machine to vary the direction and heading based on operator commands and/or programmed commands (semi- or fully autonomous). The mobile machine 110 includes an electric drive system 120 having at least one electric motor 130 and at least one battery system 140 for providing electricity to the electric motor 130. The electric drive system 120 rotates a set of ground-engaging elements 150, such as tires or continuous tracks, for propelling and maneuvering the mobile machine 110.

The rail connector assembly 160 serves to electrically connect the mobile machine 110 to the conductive rail assembly 200. The rail connector assembly 160 is attached to a side of a frame 115 of mobile machine 110 and includes a pivotable boom 170 attached to the frame 115 at a proximal end of the boom 170, an extendable and retractable trailing arm assembly 180 connected to a distal end of the boom, and a contactor assembly 190 that is capable of aligning with, and riding on along, a top planar surface of a plurality of conducting rails 210 that conduct electricity. The rail connector assembly 160 is selectively movable between an extended, power-rail connected position and a retracted position. For example, FIG. 1 shows the rail connector assembly 160 in the extended position, at an upstream end of the conductive rail assembly 200.

The rail connector assembly 160 includes electrically conductive components for delivering current from the conductive rail assembly 200 to the mobile machine 110. Suitable power electronics may be incorporated into the mobile machine 110 for purposes of power conditioning and distribution between and among the electrical drive system 120, the at least one electrical motor 130, and/or other electrical components of the mobile machine. Mobile machine 110 may utilize either a hybrid or all-electric power system and the conductive rail assembly 200 may provide electricity to either system.

As shown in FIG. 1, the exemplary mobile machine 110 is configured to travel (e.g., in a free-steering manner) along a work route or path within a job site, with the conductive rail assembly 200 positioned generally along the route or path. The plurality of conducting rails 210 of conductive rail assembly 200 are connected to a power source (e.g., a power grid, generator, and/or energy storage devices (not shown) providing electricity to the conductive rail assembly 200. The conductive rail assembly 200 may include a plurality of support poles 220 (or other support structures) secured to the ground 10, and a bracket assembly 230 attached to a top end of the each of the support poles 220 to retain the plurality of conducting rails 210 in a secured elevated position, at a generally constant height and generally parallel to the ground 10.

As described herein, conductive rail assembly 200 includes three conducting rails 210, however, fewer or more rails are possible. In this example, two of the conducting rails 210 provide electrical power at different polarities while the third conductor rail provides a reference of 0 volts (ground). The electrically conducting rail system may alternatively incorporate a three-phase power system, utilizing a three-rail power circuit in addition to a fourth conductor rail providing a reference of 0 volts (ground). It is noted that conducing rails 210 may include a generally I-beam shape with a planar top surface, although other similar rail structures may be used.

The plurality of support poles 220 ground the conductive rail assembly 200, for example, by contacting the conductor rail 210 that references 0 volts. Individual support poles 220 may be rods, poles, posts, cylinders, stanchions, or similar structures and have a length for elevating and supporting the plurality of conducting rails 210. The plurality of support poles 220 have a length sufficient to support and stabilize the plurality of conducting rails 210 at a height ranging from eight (8) to fifteen (15) feet above the ground, for example. The support poles 220 may be made of any appropriate material and may include, for example, metal materials, such as steel or aluminum, or other electrically conducting materials.

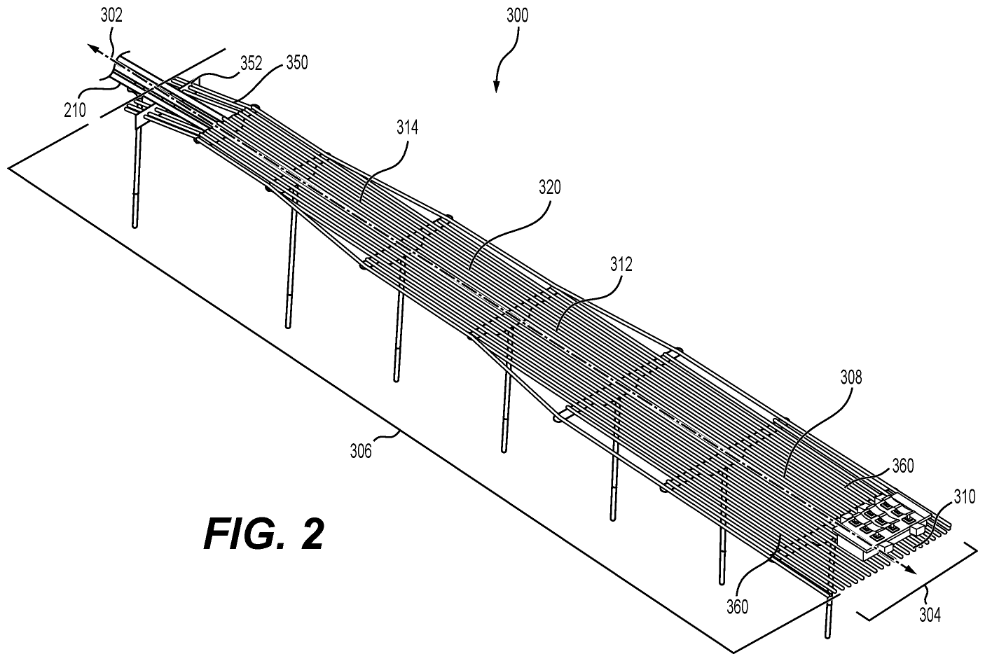

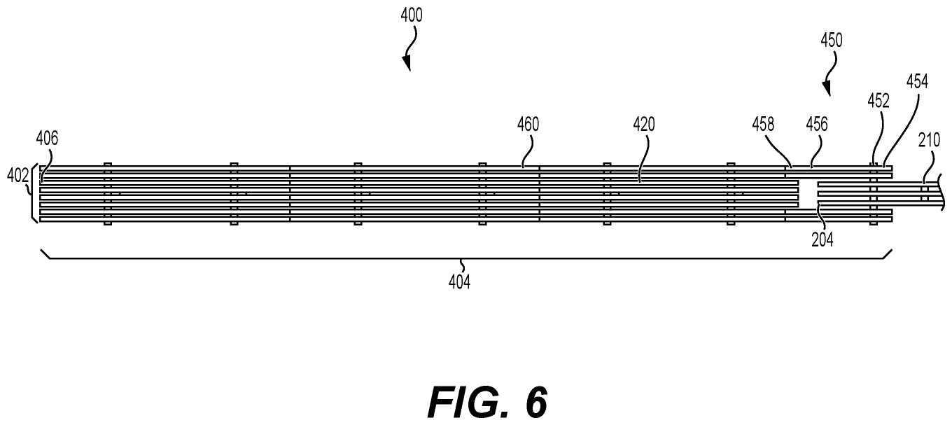

Still referring to FIG. 1, the ingress ramp assembly 300 facilitates connection of the rail connector assembly 160 of mobile machine 110 to the conductive rail assembly 200. Egress ramp assembly 400 facilitates removal or disconnecting of the rail connector assembly 160 from the conductive rail assembly 200. The ingress ramp assembly 300 may include a plurality of non-conducting rails 320 forming a capture section 308 located at an upstream-most end 310, a middle section 312, and an end section 314, with the end section 314 including a transition section 350 located at a downstream-most end of the ingress ramp assembly 300 and proximal to the conductive rail assembly 200. Similarly, the egress ramp assembly 400 may include a plurality of non-conducting rails 420 extending between a transition section 450 located at an upstream end and proximal to the conductive rail assembly 200, and a downstream-most end 406. Both ramps may have a length (306, 404 as shown in FIGS. 2 and 6, respectively) ranging from approximately 50-75 feet and have a height ranging from approximately 5 feet at its minimum height to approximately 10 feet, or even 17 feet, at its maximum height. Additionally, the ramps may be arranged to provide a slope ranging from approximately 3 to 10 degrees. As explained in more detail below, while the ingress ramp assembly 300 may include a variable width 304 (FIG. 2) and the egress ramp assembly 400 may include a constant width 402 (FIG. 6), it is understood that otherwise, both ramps include generally the same features (though reversed), and thus any discussions of the features of ingress ramp assembly 300 herein are equally applicable to the features of the egress ramp assembly 400.

Referring to FIGS. 1, 2, and 6, both the ingress ramp assembly 300 and the egress ramp assembly 400 are decoupled electrically from the conductive rail assembly 200, and the plurality of non-conducting rails (320 and 420 respectively) of the ramp assemblies may be arranged symmetrical along a common vertical plane about a longitudinal centerline (e.g. 302 in FIG. 2). These non-conducting rails 320, 420 are not connected to a power source and do not conduct electricity to the mobile machine 110. However, it is understood that the phrase “non-conducting rails” does not necessarily mean that the rails are non-conductive, but rather that the rails are not connected to a source of electricity. Thus, non-conducting rails 320, 420 may be formed of a conductive or non-conductive material. For example, the plurality of non-conducting rails 320, 420 may be made of a metallic material, such as aluminum or steel or any other suitable material. The plurality of non-conducting rails 320, 420 may include a round or circular cross-sectional shape and may be either hollow or solid construction; however, other suitable alternative shapes, such as a square cross section, may also be used.

In one example, the non-conducting rails 320, 420 are hollow, and the diameters of the plurality of non-conducting rails 320, 420 may also vary along the respective sections (e.g., 308, 312, and 314). This arrangement allows for coupling the conductive rails 320, 420 end-to-end in a slip-fit manner-inserting the smaller diameter rail into the larger diameter rail. In one example of the ingress ramp 300, the rails of the capture section 308 may include an outer diameter of 2.5 inches and an inner diameter of 2.25 inches; the rails of the middle section 312 may include an outer diameter of 2.25 inches and an inner diameter of 2.00 inches; and the rails of the end section 314 may include an outer diameter of 2.00 inches and an inner diameter of 1.75 inches. In order to couple the non-conducting rails 320 from adjacent sections (e.g., rails from the capture section 308 to the middle section 312 or rails from the middle section to the end section 314), end portions of the rails may be altered to facilitate the slip-fit connection. For example, a portion of the outer diameter of a smaller diameter rail may be tapered to be received by the inner diameter of a larger diameter rail; or a portion of the inner diameter of a larger diameter rail may be honed to receive the outer diameter of a smaller diameter rail. Once connected, an end portion of smaller diameter rail 320 is nested within an end portion of the larger diameter rail, thereby providing a robust connection between the plurality of non-conducting rails. The same different sized non-conductive rails 420 with slip-fit connections may be utilized in reverse on the egress ramp 400, e.g. larger to smaller as the contactor assembly 190 travels downstream. This arrangement provides a smoother path for the contactor assembly 190.

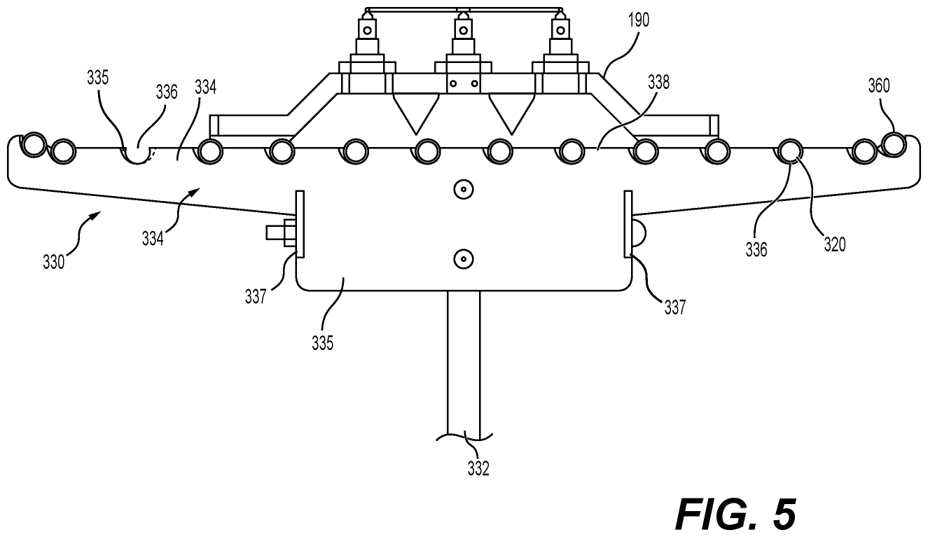

Also, the ingress ramp assembly 300, or both ramp assemblies, may include one or more elevated outer rails 360 (FIG. 5), which are raised above a planar arrangement of the non-conducting rails 320 relative to a central portion of the ramp assembly, for providing a shoulder or guardrail for the contactor assembly 190. These outer non-conducting rails 360, 460 may extend through along the entire length 306, 404 of each ramp respectively. For example, in the ingress ramp assembly 300, the outer rails 360 may extend along the entire length 306 and thus may be included in each section 308, 312, 314, and 350 of the ingress ramp assembly 300. Similarly, in the egress ramp 400 (FIG. 6), the outer rails 460 may also extend along the entire length 404 of the egress ramp and the transition section 450 of the egress ramp.

As shown in FIGS. 1 and 2 and noted above, the ingress ramp assembly 300 may include a varying width 304 tapering from the distal end 310 to transition section 350. The capture section 308 located at the distal end or upstream portion 310 includes a maximum width of the ingress ramp assembly 300. The maximum width of the capture portion 308 allows for a larger target for receiving contactor assembly 190 of the rail connector assembly 160 (FIG. 2, where the contactor assembly is shown to be initially off-center upon entry). In the example of the ingress ramp assembly 300, the capture section 308 includes twelve (12) non-conducting rails 320 along its width. However, the capture section 308, and the other sections of the ingress ramp assembly 300, may include more or less non-conducting rails 320 than those described herein.

At a transition between the capture section 308 and the middle section 312 (i.e., the downstream end of the capture section 308), a pair of outermost non-conducting rails 320 of the capture section 308 on opposite sides of the longitudinal centerline 302 are terminated, resulting in a narrower width for the subsequent middle section 312 relative to the maximum width of the capture section. As noted above, the middle section 312 of the ingress ramp assembly 300 extends between the capture section 308 and the end section 314. In the exemplary ingress ramp assembly 300, the middle section 312 includes ten (10) non-conducting rails 320 along its width 304. Similar to the transition between the capture section 308 and the middle section 312, the transition between the middle section 312 and the end section 314 includes a second pair of outermost non-conducting rails 320 on opposite sides of the longitudinal centerline 302 terminating prior to the end section 314, and resulting in a narrower width 304 for the subsequent end section 314 relative to the narrower width of the middle section.

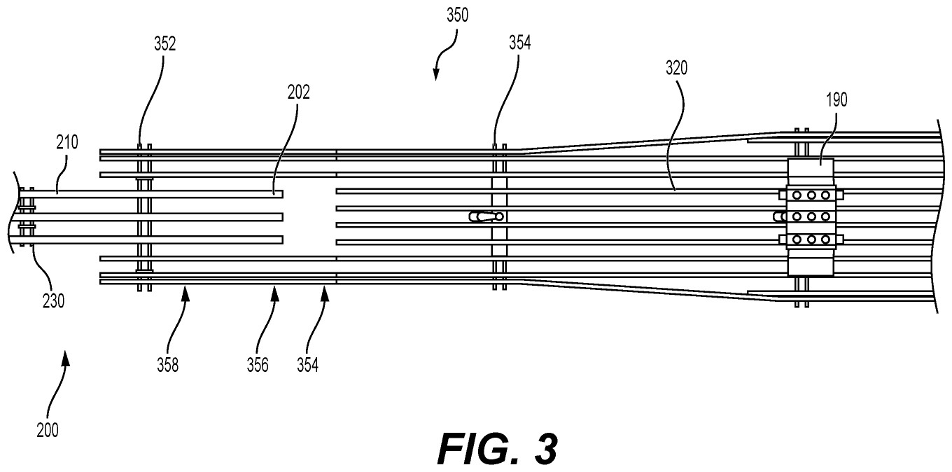

The end section 314, as shown in FIG. 2, is located downstream of middle section 312 and includes the transition section 350. At this end section 314, the contactor assembly 190 begins its transition from sliding along the ingress ramp assembly 300 to being placed on the plurality of conducting rails 210 via the transition section 350. In the example of the ingress ramp assembly 300, the end section including eight (8) non-conducting rails 320 along its width 304, with four (4) inner or central non-conducting rails terminating prior to four (4) outer non-conducting rails (shown in FIGS. 2 and 3).

As shown in FIG. 2, the variable width 304 of the ingress ramp assembly 300 narrows or tapers in a downstream direction—as the contactor assembly 190 approaches conductive rail assembly 200. More specifically, the variable width 304 of the ingress ramp assembly 300 includes the maximum width located at the distal end 310 of the capture section 308 and the minimum width located in the transition section 350 of end section 314, proximal to an entry end 202 of the conductive rail assembly 200.

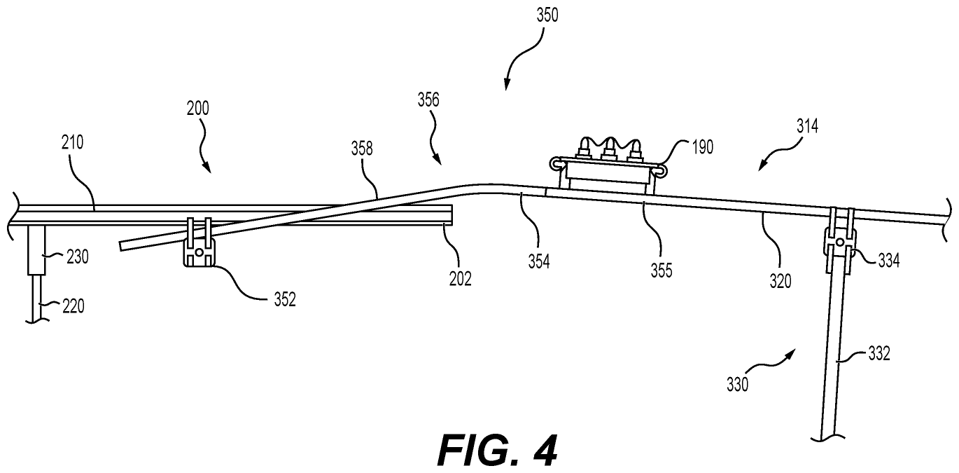

FIGS. 3 and 4 depict a top and side view, respectively, of the transition section 350 of ingress ramp assembly 300. As noted above, transition section 350 is located at a downstream end of the ingress ramp assembly 300 and adjacent to the entry end or upstream end 202 of the conductive rail assembly 200. As best shown in FIG. 3, the non-conducting rails 320 of the transition section 350 form a minimum width that is greater than a maximum width of the conductive rail assembly 200. As best shown in FIG. 4, the transition section 350 includes non-conducting rails 320 forming an upstream portion 354 that extends along the same slope as the upstream ramp sections (308, 312, and 314) and to a height inflection 356, and a downstream portion 358 angled downwardly away from the height inflection. At the height inflection 356, the ingress ramp assembly 300 may be at a height above the ground ranging from 8-16 feet, and positioned above the conductive rail assembly 200. The height inflection 356 may also provide a termination location for a number of central non-conducting rails, such as four (4) non-conducting rails, as best shown in FIGS. 2 and 3. Height inflection 356 may provide a curved transition or a non-curved or straight, slope transition for the remaining four (4), outer non-terminated, non-conducting rails 320. As best shown in FIGS. 1, 3, and 4, downstream portion 358 of the transition section 350 (non-terminated, non-conducting rails 320) overlaps a portion of the conductive rail assembly 200 in the upstream-downstream or distal to proximal direction. Further, the downwardly-angled downstream portion 358 of transition section 350 may vertically intersect, and then extend vertically below the conductive rail assembly 200. From the height inflection 356, the plurality of non-conducting rails 320 of the downstream portion 358 form a transfer portion for the contactor assembly 190 to move from the ingress ramp assembly 300 to the conducting rails 210. Since both the plurality of non-conducting rails 320 and the plurality of conducting rails 210 are in a spaced configuration, neither set of rails directly touch each other at this intersection. The downstream portion 358 of transition section 350 may include a retaining bracket 352 for aligning and retaining the non-conducting rails 320. The retaining bracket 352, shown in FIGS. 3 and 4, may be attached to an underside portion of the plurality of conducting rails 210 and may be made of a dielectric material, such pultruded fiberglass-reinforced polymer (FRP) or other similar non-conducting material.

Similar to the conducting rail assembly 200, and as shown in FIG. 1, the ramp assemblies 300, 400 include a support assembly 330 including plurality of support poles 332 (or other support structures) secured to the ground 10, and a bracket assembly 334 attached to a top end of the each of the support poles 332 to retain the plurality of non-conducting rails 320 in a secured elevated position. FIG. 5 illustrates a front, cross-section view of the ingress ramp assembly 300 at the capture section 308, with the contactor assembly 190 sliding along at top of the plurality of non-conducting rails 320. The bracket assembly 334 of the support assembly 330 may include, one or more retaining plates 335 configured to receive and secure the non-conducting rails 320, 360 at a top surface thereof. As discussed above, the ingress ramp assembly 300 includes a longitudinal centerline 302 (FIG. 2), and the number of non-conducting rails 320 found on one side of the centerline 302 is mirrored on the other side. Additionally, as noted above, the outer rails 360, 460 of the ramp assemblies are elevated relative to the other non-conducting rails 320,420, creating the elevated shoulder to retain the contactor assembly 190.

According to one aspect, the bracket assembly 334 may be formed of a pair of retaining plates 335 attached to a top end of the each of the support poles 332 to retain the plurality of non-conducting rails 320. The retaining plates 335 may include a plurality of rail receiving recesses 336 located along a pole support surface 338, with the recesses 336 being sized to accommodate the various sizes of the plurality of non-conducting rails 320. The pair of retaining plates 335 may have an asymmetrical shape and may be arranged in a mirrored or reversed orientation relative to one another. Accordingly, the asymmetrical rail receiving recesses 336 may include a shallow opening on a first side of the recess 336 (left side in FIG. 5) and a retention overhang located on a second side of the recess 336. The asymmetrical shape of the rail receiving recesses 336 may be configured to extend to a height over 50% of an individual non-conducting rail 320 within the body of the plate 335 and collinear with the pole support surface 338. For example, as shown in FIG. 5, a pair of the retaining plates 335 may be placed such that the plurality of retention overhangs of each plate face in opposing directions. This allow for placing the non-conducting rails 320 in the recesses 336 (due to the shallow openings), and then clamping them in places by moving the retaining plates 335 laterally in opposite directions with respect to each other. The retaining plates 335 may be secured in the clamping position by pair of locking plates 337 and a fastener such as a bolt (shown in FIG. 5). Thus, the retention overhangs of each plate are positioned on opposite sides of the individual non-conducting rail 320, thereby securing and retaining of the individual non-conducting rail 320 within the recess 336. The overhang and shallow retaining plates 335 are depicted in FIG. 5 where a non-conducting rail has been removed.

As shown in FIG. 1, a plurality of support assemblies 330 are horizontally spaced apart, and are of varying heights to vertically support the non-conductive rails 320, 360 along the ingress ramp assembly 300. FIGS. 2 and 3 also illustrate that, as the number of non-conducting rails 320 is decreased along the length of the ingress ramp 300, the support assemblies 330, specifically the one or more plates 334, are sized to retain and support the number of rails present. For example, the plates 334 utilized in the capture section 308 will be substantially larger in size and include more rail receiving recesses 336 than the plates used in the end section 314.

FIG. 6 illustrates the egress ramp assembly 400. As noted above, the egress ramp assembly includes many of the same features as ingress ramp assembly 300, (e.g., the plurality of con-conducting rails 420, the transition section 450, and elevated outer rails 460), and similar features are identified with 100 added to the reference numbers 320, 350, 352, 354, 356, 358, and 360 from ingress ramp assembly 300. In contrast to ingress ramp assembly 300, egress ramp assembly 400 may include a constant width 402 along its length 404, for example, eight (8) non-conducting rails 420, 460 along its full length. However, the egress ramp assembly 400 may include a variable width similar to that of the ingress ramp assembly 300. While the egress ramp assembly 400 may include a slope similar to ingress ramp assembly 300 (but opposite in the upstream to downstream direction (FIG. 1), the egress ramp assembly 400 may alternatively include a constant height for its full length 404. Similar to ingress ramp assembly 300, egress ramp assembly 400 may include a height inflection 456 for facilitating a lifting of the contactor assembly 190 from the conductive rails 210 with an upstream portion 454 and transitioning to the plurality of non-conducting rails 420 with the downstream portion 458.

As noted above, both the ingress ramp assembly 300 and the egress ramp assembly 400 are not connected to a power source and are therefore non-conducting. In contrast, the plurality of conducting rails 210 are connected to a power source and distribute electrical energy along their length.

### INDUSTRIAL APPLICABILITY

The disclosed aspects of the ingress and egress ramp assembly 300, 400 can be used for safely and securely connecting and removing a power rail connector from a mobile machine onto a conductive rail assembly at an elevated height to charge or drive the mobile machine. For example, the figures depict the placement of the contactor assembly 190 onto the conductive rail assembly 200 via an ingress ramp assembly transition section 350, and the removal of the power rail connector from the rail system using an egress ramp assembly transition section 450.

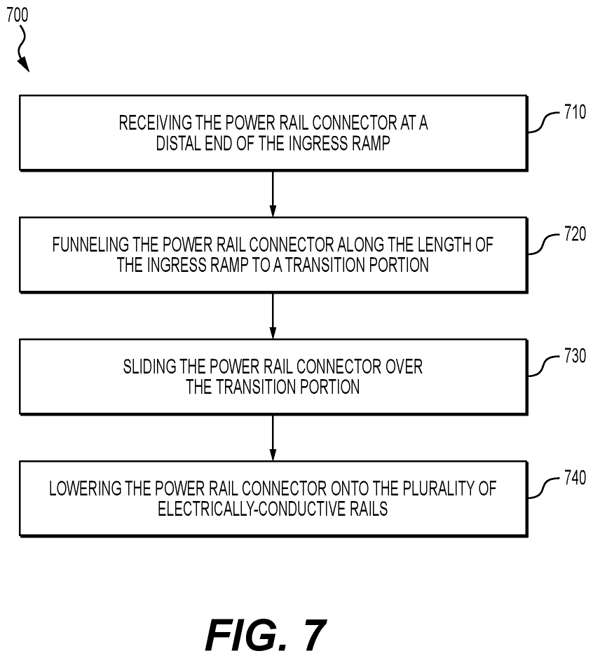

FIG. 7 illustrates an example method 700 for guiding a contactor assembly 190 onto the conductive rail assembly 200. The method 700 includes a step 710 of positioning or aligning the contactor assembly 190 within a width of the capture section 308 of the ingress ramp assembly 300, and then receiving the contactor assembly 190 on the top surface of the non-conducting rails 320 within outer rails 360. As noted above, the capture section 308 of the ingress ramp assembly 300 includes a maximum width of the variable width 304, thus creating a larger target for receiving the contactor assembly 190.

Step 720 involves the funneling or sliding of the contactor assembly 190 along a top surface of the length 306 of the ingress ramp assembly 300 and upstream to the ingress transition section 350. The contactor assembly 190 is raised and funneled as it travels along the ingress ramp assembly toward the transition section 350. The ingress ramp assembly 300 extends from a minimum height at the distal end 310 to a maximum height at a height inflection 356 of the transition section 350, thereby raising the contactor assembly 190 above the height of the conductive rail system (shown in FIG. 4). Additionally, the outer rails 360, as discussed above, serves to cradle the contactor assembly 190 within the ingress ramp assembly 300.

In step 740, the contactor assembly 190 is lowered from the maximum height of the height inflection 356 onto the plurality of conducting rails 210. During this step, the contactor assembly 190 slides down the downstream portion 358 of the transition section 350 towards the intersection point of the plurality of non-conducting rails 320 and the plurality of conducting rails 210.

In step 740, the contactor assembly 190 is placed on a top surface of the plurality of conducting rails 210, thereby completing the method, and allowing for electrical connection of the contactor assembly 190 with the conducting rails 210.

In accordance with the present disclosure, the ingress and egress ramp system 300, 400 for the mobile machine 110 facilitates the connection of the rail connector assembly 190 onto and off of the conductive rail assembly 200, resulting in a safer and secure electrical connection to a power source. The ingress ramp assembly 300 allows for the machine operator (or autonomous commands) to easily extend the rail connector assembly 190 away from the frame of the mobile machine 110 and align, contact, and funnel the rail connector assembly along the length of the ingress ramp assembly 300. Both the ingress and the egress ramp assemblies 300, 400 may utilizes elevated shoulders and gravity to help ensure that the contactor assembly 190 will be controlled along the length of the ramp assemblies 300, 400, and help engage with the conducting rails 210.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. An electrical conductive system for a free-steering mobile machine, comprising:
a conductive rail assembly including a plurality of conducting rails extending generally parallel to the ground, the plurality of conducting rails configured to provide electricity to the free-steering mobile machine; and
an ingress ramp assembly located at one end of the conductive rail assembly, the ingress ramp assembly including:
a plurality of non-conducting rails detached from the plurality of conducting rails, and extending to a height above the conductive rail assembly.

2. The electrical conductive system of claim 1, wherein the plurality of non-conducting rails of the ingress ramp assembly provide an ingress ramp assembly width that is greater than a width provided by the plurality of conducting rails over the entire conductive rail assembly.

3. The electrical conductive system of claim 2, wherein the ingress ramp assembly width narrows in a direction toward the conductive rail assembly.

4. The electrical conductive system of claim 1, wherein the ingress ramp assembly includes a central portion including a plurality of non-conducting rails extending parallel to one another and in a common plane, and a plurality of outer non-conducting rails located above the common plane.

5. The electrical conductive system of claim 1, wherein the plurality of non-conducting rails are round.

6. The electrical conductive system of claim 1, wherein the ingress ramp assembly includes a transition section overlapping the conductive rail assembly.

7. The electrical conductive system of claim 6, wherein the transition section intersects the conductive rail assembly, and the transition section includes a height inflection upstream of the intersection.

8. The electrical conductive system of claim 6, wherein the transition section includes central rails that terminate upstream of outer rails.

9. The electrical conductive system of claim 1, wherein the conductive rail assembly extends to a height in a range of approximately 8-15 feet.

10. The electrical conductive system of claim 1, further including an egress ramp assembly located at another end of the conductive rail assembly, the egress ramp assembly including:
a plurality of non-conducting rails detached from the plurality of conducting rails, and extending to a height above the conductive rail assembly.

11. The electrical conductive system of claim 1, wherein the conductive rail assembly and ingress ramp assembly are supported above the ground by a plurality of poles and rail brackets.

12. An electrical conductive system for a free-steering mobile machine, comprising:
a conductive rail assembly including a plurality of conducting rails extending generally parallel to the ground, the plurality of conducting rails configured to provide electricity to the free-steering mobile machine; and
an ingress ramp assembly located at one end of the conductive rail assembly, the ingress ramp assembly including:
a plurality of non-conducting rails extending to a height above the conductive rail assembly and
wherein a width of the ingress ramp assembly provided by the plurality of non-conducting rails narrows in a direction toward the conductive rail assembly.

13. The electrical conductive system of claim 12, wherein the ingress ramp assembly includes a central portion including a plurality of non-conducting rails extending parallel to one another and in a common plane, and a plurality of outer non-conducting rails located above the common plane.

14. The electrical conductive system of claim 12, wherein the plurality of non-conducting rails are round.

15. The electrical conductive system of claim 12, wherein the ingress ramp assembly includes a transition section overlapping the conductive rail assembly.

16. The electrical conductive system of claim 15, wherein the transition section intersects the conductive rail assembly, and the transition section includes a height inflection upstream of the intersection.

17. The electrical conductive system of claim 15, wherein the transition section includes central rails that terminate upstream of outer rails.

18. The electrical conductive system of claim 12, wherein the conductive rail assembly extends to a height in a range of approximately 8-15 feet.

19. A method of using an ingress ramp assembly to align a contactor assembly of a free-steering mobile machine onto a conductive rail assembly, comprising:
aligning the contactor assembly onto an upstream portion of the ingress ramp assembly;
sliding the contactor assembly on a top surface of the ingress ramp assembly and up the ingress ramp assembly to a height above the conductive rail assembly; and
lowering the contactor assembly onto the conductive rail assembly.

20. The method of claim 19, further including funneling the contactor assembly during the sliding of the contactor assembly.
